(19) United States
(12) Patent Application Publication
(10) Pub. No.: US 2006/0036832 A1
(43) Pub. Date: Feb. 16, 2006

(54) Virtual computer system and firmware updating method in virtual computer system

(75) Inventor: Yasushi Makiyama, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/224,069

(22) Filed: Sep. 13, 2005

Related U.S. Application Data
(63) Continuation of application No. PCT/JP03/02998, filed on Mar. 13, 2003.

(51) Int. Cl. G06F 15/00

(52) U.S. Cl. 712/1

(57) ABSTRACT

A virtual computer system includes computers (1, 2) each having a first operating system executed when the virtual computer system is built and a second operating system of when each computer operates individually. Each of the computers (1, 2) comprises a booting unit (35A) for booting the first or second operating system, rewriting means for updating the firmware of the computer when the second operating system is booted, means for setting the booting unit as a unit for booting the first operating system, means for re-booting the computer, and means for building a virtual computer system by establishing synchronization at least between one computer and another when the first operating system is booted. Further, means for setting the booting unit as a unit for booting the second operating system when the virtual computer system is built and means for stopping the virtual computer system are provided.

### CROSS-REFERENCE TO RELATED APPLICATION

This is a continuation of Application PCT/JP2003/002998, filed on Mar. 13, 2003, now pending, the contents of which are herein wholly incorporated by reference.

### BACKGROUND OF THE INVENTION

1. Technical Field

The present invention relates to an update of firmware in a fault tolerance system.

2. Background Arts

Known as one type of fault tolerance system is a system in which redundancy is ensured by combining a plurality of general-purpose computer servers (which will hereinafter simply be called general-purpose servers) such as PC (personal computer) servers and are thus made to function as one single virtual computer (refer to, e.g., Non-patent document 1 given below).

This type of fault tolerance system takes a configuration of combining the general-purpose servers, and hence there might be a case of desiring to update firmware included in each computer server. This case is exemplified such as desiring to update BIOS in the case of the PC server, desiring to enable BIOS to support a new piece of hardware, and desiring to update the firmware of a variety of control units, e.g., a PCI (Peripheral Component Interconnect) bus controller.

The conventional fault tolerance system configured by the general-purpose servers is not, however, provided with such a function of executing the update batchwise as the whole system. Accordingly, a user must update individually the firmware of the general-purpose servers on a one-by-one basis.

Note that the following Patent documents 1 and 2 are known as general technologies of updating the firmware of other computers from on a host computer.

Non-Patent Document 1

Marathon Endurance 6200, Searched on Feb. 7, 2003, Interface<URL:http://www.ens.co.jp/public/tc3_{—}0000.nsf/product s/MarathonEndurance6200?OpenDocument>

Patent Document 1

Japanese Patent Application Laid-Open Publication No. 2001-22572

Patent Document 2

Japanese Patent Application Laid-Open Publication No. 2002-373143

### SUMMARY OF THE INVENTION

The present invention was devised in view of the problems inherent in these prior arts. Namely, it is an object of the present invention to provide a function of updating firmware included in respective general-purpose servers batchwise by a system in a fault tolerance system in which a plurality of computers such as general-purpose servers are combined.

The present invention adopts the following means in order to solve the problems given above. Namely, the present invention is a virtual computer system including a plurality of computers each having a first operating system executed when configuring the virtual computer system and a second operating system used when the computers individually function.

Then, the computer comprises a boot module starting up the first operating system or the second operating system, a rewriting unit updating firmware of the computer when starting up the second operating system, a unit setting the boot module so as to start up the first operating system, a unit restarting up the computer, and a unit configuring the virtual computer system by synchronization with at least one other computer when the first operating system is started up. Moreover, in a virtual computer system configured status, there are provided a unit setting the boot module so as to start up the second operating system and a unit stopping the virtual computer system.

Thus, in the virtual computer configured status, the boot module is set for starting up (booting) the second operating system, and the virtual computer system is stopped, whereby the virtual computer is separated back into the individual (physical) computers. Then, when each computer is restarted up (rebooted), the second operating system is booted, and the firmware of each computer is updated.

Preferably, each of the computers may include a first computer having an input/output unit and a second computer employing the input/output unit of the first computer, and the second computer may be provided with at least a boot module starting up the first operating system or the second operating system, and a rewriting nit updating firmware of the second computer when starting up the second operating system.

The first computer is a computer called, e.g., an input/output processor. Further, the second computer is a computer called, e.g., a main processor.

Preferably, the boot module may be set in an unaccessible protected status in a virtual computer configured status, and the unit setting the boot module so as to start up the second operating system may have a unit that accesses the boot module in the protected status. The unit accessing the boot module kept in the protected status is, for instance, a unit that cancels the protected status.

Further, the present invention may be a method by which a computer, other apparatus, other machines, etc. execute any one of the processes described above. Still further, the present invention may also be a program that makes a computer, other devices, other machines, etc. actualize any one of the functions described above. Yet further, the present invention may also be a recording medium recorded with this program, which can be read by a computer etc.

### BRIEF DESCRIPTION OF THE DRAWINGS

FIG. 1 is a diagram of a system architecture of a computer system according to one embodiment of the present invention;

FIG. 2 shows an example of a firmware configuration in computers 1 and 2 shown in FIG. 1;

FIG. 3 shows an example of description of Autoexec.bat shown in FIG. 2; and

FIG. 4 is a flowchart showing an example of an automatic updating operation.

### DETAILED DESCRIPTION OF THE INVENTION

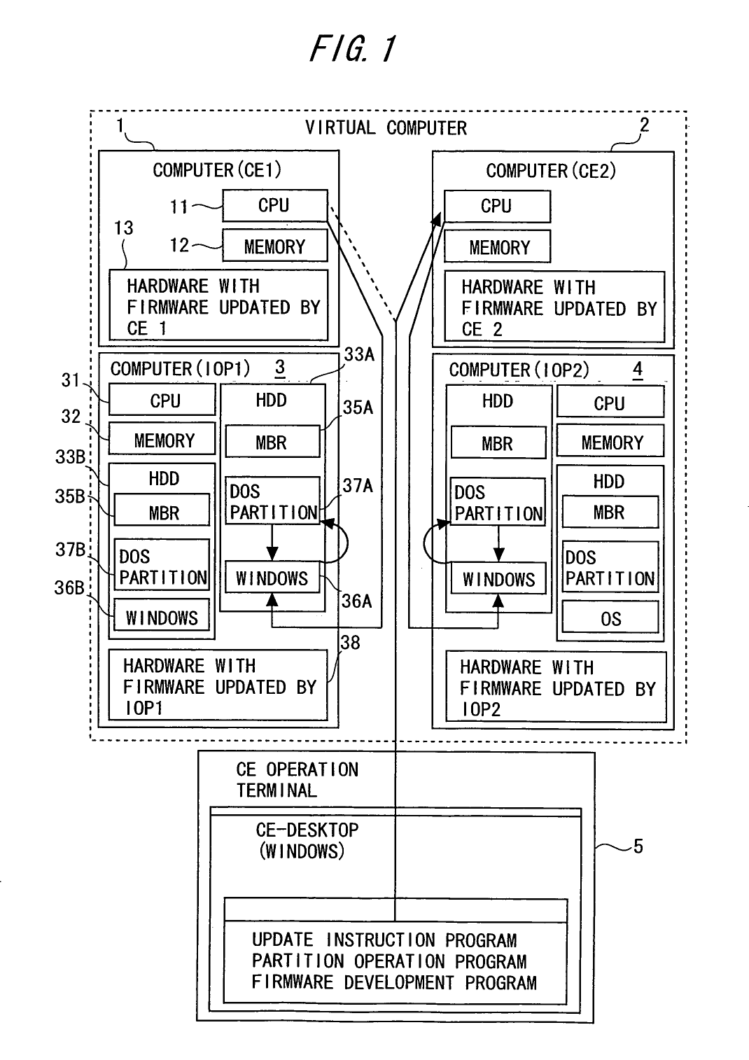

A computer system according to a first embodiment of the present invention will hereinafter be described with reference to drawings in FIGS. 1 through 4.

<System Architecture>

FIG. 1 is a diagram of a system architecture of the computer system according to one embodiment of the present invention. As shown in FIG. 1, this computer system has computers 1-4 and an operation terminal 5.

Among these components, the computers 1 and 2 execute the same process in synchronization with each other in a normal operating status. With this contrivance, the computers 1 and 2 configure a main processor having a redundant configuration. As shown in FIG. 1, the computer 1 includes a CPU 11, a memory 12 and hardware 13. Note that the computer 2 has the same configuration as the computer 1 has, and hence its description is omitted.

The CPU 11 executes a program developed on the memory 12, thereby providing a function as the main processor. The memory 12 is stored with a program executed by the CPU 11 or with data processed by the CPU 11.

The hardware 13 is exemplified by a variety of processing circuits such as an interface board via which the computer 1 communicates with the computer 3 or 4 and a graphics board. The hardware 13 is provided with a storage unit for storing various types of firmware.

The firmware is defined as software installed into a device in order to perform basic control of the hardware. In the present embodiment, a rewritable piece of software developed on a rewritable nonvolatile memory, e.g., a flash memory, is called the firmware. The firmware of the computer 1 is, for example, BIOS (Basic Input/Output System).

The computer 3 functions as an Input/Output processor (I/O processor) of the computer 1. Similarly, the computer 4 functions as the I/O processor of the computer 1. The I/O processor, under the control of the main processor, accesses the variety of devices connected to the I/O interface, and inputs and outputs information.

Namely, the computer 3 receives an instruction of the. computer 1, and transfers and receives data to and from the devices (connected) to the unillustrated I/O interface. Further, the computer 3 reports, to the computer 1, a result of the accesses to the devices to the I/O interface.

In such a case that the computer 1 accesses hard discs 33A, 33B, etc. of the computer 3, however, this access is reflected also in the hard discs built in the computer 4. In the present embodiment, the hard discs of the computer 3 and the hard discs of the computer 4 have a mirroring configuration (all these hard discs are stored with the same data) with respect to each other.

Note that the function of the computer 4 with respect to the computer 2 is the same as the function of the computer 3 with respect to the computer 1.

As shown in FIG. 1, the computer 3 includes a CPU 31, a memory 32, hard discs 33A, 33B and hardware 38.

Moreover, the hard disc 33A has a master boot record (MBR) area 35A, a first OS area 36A and a second OS area 37A, respectively. Similarly, the hard disc 33B has a master boot record (MBR) area 35B, a first OS area 36B and a second OS area 37B, respectively.

Herein, the hard disc 33A is a record area for booting the computer 1. To be specific, (a program module in) the master boot record area 35A is executed when booting the computer 1, and loads the computer 1 with any one of an OS in the first OS area 36A and an OS in the second OS area 37A.

The first OS area 36a is stored with the OS used in the normal operating status. The first OS used in the normal operating status is an OS executed in a case where the present computer system provides a user with a service such as information processing. The present embodiment involves employing Windows (Trademark) of Microsoft Corp., USA. as the first OS.

Further, the second OS area 37A is stored with the second OS used when updating the firmware. Herein, DOS is employed as the second OS.

The master boot record 35A contains designation as to which OS, the OS in the first OS area 36A or the OS in the second OS area 37A, should be booted. When booting the computer 1, the first OS area 36A or the second OS area 37A is selected, and the OS in the selected area is booted.

Furthermore, the hard disc 33B is a record area for booting the computer 3. Specifically, (a program module in) the master boot record area 35B is executed when booting the computer 3, and loads the computer 3 with any one of a first OS stored in the first OS area 36B and a second OS in the second OS area 37B.

Note that the hard discs 33A and 33B may be a plurality of hard discs in a physical sense. Further, the hard discs 33A and 33B may also be different areas (which are, e.g., different partitions (configuring a plurality of drives in a virtual sense)) on the single hard disc.

The hardware 38 is, for instance, an interface such as PCI (Peripheral Component Interconnect) and USB (Universal Serial Bus), and a LAN board, etc. The computer 3 accesses the I/O devices to the hard discs or accesses a network, and thus provides a function as an I/O processor.

The hardware 38 is, as in the case of the hardware 13 of the computer 1, stored with various types of firmware. Accordingly, the hardware 38 has the rewritable nonvolatile memory, e.g., the flash memory etc. Further, the firmware of the computer 3 is exemplified by, e.g., the BIOS, firmware for a PCI bus controller, firmware stored on a RAID (Redundant Array of Inexpensive Discs) controller, and so on.

With the configuration described above, the computers 1-4 function as a single computer (which will hereinafter be called a virtual computer) to the external device (e.g., the operation terminal 5 on the network). Namely, the operation terminal 5 recognizes these computers 1-4 as one virtual computer on the network.

The operation terminal 5 is, e.g., a personal computer. The operation terminal 5 accesses the computer 1 and the computer 2 via the LAN board connected to the I/O interface of the computer 3 (or 4).

As described above, each of the computers 3 and 4 is installed with the LAN board. In this case, the operation terminal 5 accesses the virtual computer via the LAN board (which is referred to as, e.g., an active board) of any one of the computers 3 and 4. At this time, the other LAN board, which is not the active board, is in an always-usable status as a standby board.

Further, within the virtual computer, the computers 1 and 2 execute the same process in synchronization with each other. The operation terminal 5, however, accesses the computers 1 and 2 as single nodes by use of single IP addresses thereof.

As explained above, the hard discs of the computers 3 and 4 are in the mirroring relationship with each other. Hence, the input and the output to the virtual computer are the input and the output to the hard discs having the mirroring configuration via the computers 3 and 4 serving as the I/O processors.

In the present embodiment, the program under the control of the first OS of the computer 1 (and 2) actualizes the mirroring configuration (which is called software mirror) via the computers 3 and 4. The embodiment of the present invention is not, however, limited to such a mirroring method. For instance, the mirroring among the hard discs may be actualized under the control of the computers 3 and 4 or under the control of the hardware within the hard discs.

<Outline of Updating Operation of Firmware>

A procedure of updating the firmware of each of the computers 1-4 will hereinafter be explained.

(1) Updating Operation in Single Computer

A procedure of updating solely the firmware of the computer 1 or 2 will hereinafter be explained. In an initial status, the first OS is booted in each of the computers 1 and 2. In this case, the second OS 27A is concealed so as not to be seen from on the first OS. This intends to avoid crash action at the second OS area 37A. This is, for example, in such a case that the first OS is Windows while the second OS is DOS, attained simply by setting a partition ID, unrecognizable to Windows, to a DOS partition as a different partition in which DOS is stored.

Given hereinafter is an explanation of an outline of the procedure of updating the firmware of the individual computer 1 or 2. An assumption herein is that the firmware of each of the computers 1 and 2 is individually updated in a status where the computers 3 and 4 as the I/O processors are started up.

(1-1) On the first OS, a firmware development program develops a firmware acquired via the network into a null area of the second OS.

(a) Namely, the first OS cancels the concealed status so as to make temporarily readable from and writable to the second OS from on the first OS.

(b) The firmware acquired from the network is developed (written) into the second OS.

The firmware contains a script (e.g., Autoexec.bat in DOS) automatically executed when booting the second OS. Therefore, when the second OS is booted, a series of update commands (which are assumed to be Update.exe) are executed automatically.

Further, at the end of the script (Autoexec.bat etc.), a command (which is assumed to be Chgpid.exe) for setting the master boot record 35A and the second OS area 37A and a command (which is assumed to be Reboot.exe) for rebooting the system, are invoked so that the first OS can be booted when booting the system next time.

(c) The first OS returns the concealed status to the original status.

(1-2) On the first OS, a partition operating program sets the master boot record 35A and the second OS area 37A so that the system can be started up from the second OS area 37A when booting the system next time.

(1-3) The system is rebooted. The second OS (e.g., DOS) is thereby booted from the second OS area.

(1-4) The script (e.g., Autoexec.bat) is executed.

(1-5) Chgpid.exe is invoked from the script (e.g., Autoexec.bat), and the master boot record 35a and the second OS area 37A are set so that the first OS can be booted when booting the system next time.

(1-6) Update.exe is invoked from the script (e.g., Autoexec.bat), and the firmware is updated.

(1-7) Reboot.exe is invoked from the script (e.g., Autoexec.bat), the system is rebooted. The first OS (e.g., Windows) is thereby booted.

(1-8) A result as to whether the firmware can be normally updated or not is checked.

(2) Updating Operation of Firmware on Virtual Computer

The above example of the automatic updating operation is applied as it is to the virtual computer.

(2-1) On the first OS, (1-1) through (1-2) in the example (1) of the updating operation on the single computer are executed.

(2-2) The system is rebooted. At the point of time when the first OS stops, the redundancy (the synchronization between the computers 1 and 2, and the synchronization between the computers 3 and 4) of the virtual computer is canceled. On the computer 1 (and 2), the second OS is booted from the second OS area 37A (e.g., the DOS partition) of the computer 3 or 4.

(2-3) The processes (1-4) through (1-8) are executed. The firmware of the hardware existing on the computers 1 and 2 is updated. The redundancy of the virtual computer is restored at the point of time when the first OS is booted.

(3) Operations on Computers 3 and 4 (I/O Processors)

The firmware updating operation on the computers 3 and 4 is the same as the operation (1) as the single computer. Namely, the computers 3 and 4 respectively have unillustrated system consoles and execute, through these system consoles, individually updating the firmware in the same procedure as (1) .

<Configuration of Firmware of Computer>

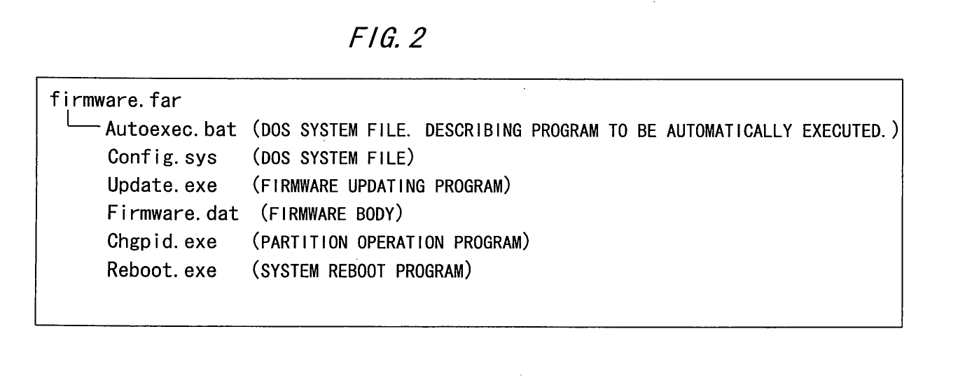

FIG. 2 shows an example of a configuration of the firmware (Firmware.far) on the computers 1 through 4 shown in FIG. 1. The firmware on the computers 1 and 2 is stored in the second OS area 37A of the computer 3. Further, the firmware on the computers 3 and 4 is stored in the second OS area 37B (see FIG. 1).

As shown in FIG. 2, the firmware on the computers 1 through 4 contains respective pieces of programs (or scripts) such as Autoexec.bat, Config.sys, Update.exe, Firmware.dat, Chipid.exe and Reboot.exe.

Autoexec.bat is a system file of the second OS (e.g., DOS) and describes a program executed when booting the DOS.

Config.sys is a system file of the second OS (e.g., DOS) and executes, for example, a connection of a peripheral device.

Update.exe is a firmware update program. Furthermore, Firmware.dat is firmware that is updated by Update.exe this time. Update.exe stores data arranged just posterior to Update.exe itself as a new piece of firmware in a firmware storage location (e.g., the nonvolatile memory of the interface board with the computer 3, the graphics board, etc.) within the predetermined hardware.

Chgpid.exe is a program which sets in the master boot record 35A so that the OS to be booted is switched over between the first OS and the second OS. Chgpid.exe, for example, sets which area, the first OS area 36A or the second OS area 37A, the OS should be booted from in the master boot record 35A shown in FIG. 1.

Reboot.exe is a program for rebooting the system.

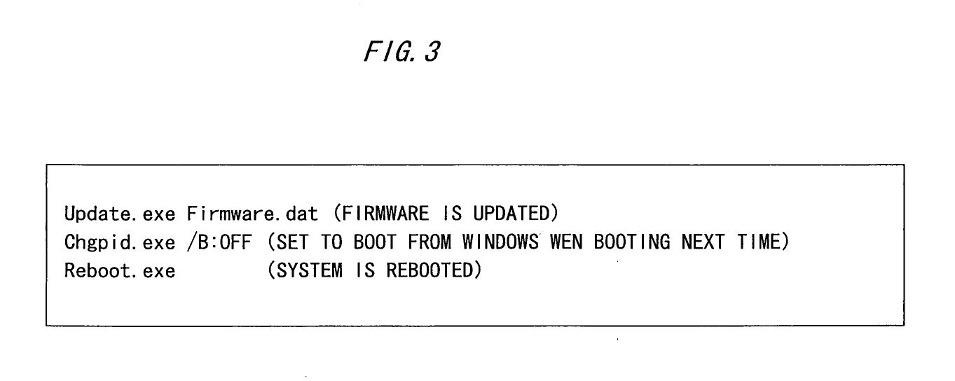

FIG. 3 shows an example of description of Autoexec.bat. As stated above, Autoexec.bat has a description of command executed when booting DOS.

As shown in FIG. 3, in the present embodiment, Autoexec.bat at first executes updating the firmware by a command line such as “Update.exe Firmware.dat”. With this command line, Firmware.dat arranged just posterior to Update.exe is written as a new piece of firmware to the nonvolatile memory within the predetermined hardware.

Next, Autoexec.bat sets the first OS (e.g., Windows) as the OS to be booted next by “Chgpid.exe/B:OFF”.

Subsequently, Autoexec.bat executes rebooting the system by Reboot. exe.

<Processing Flowchart>

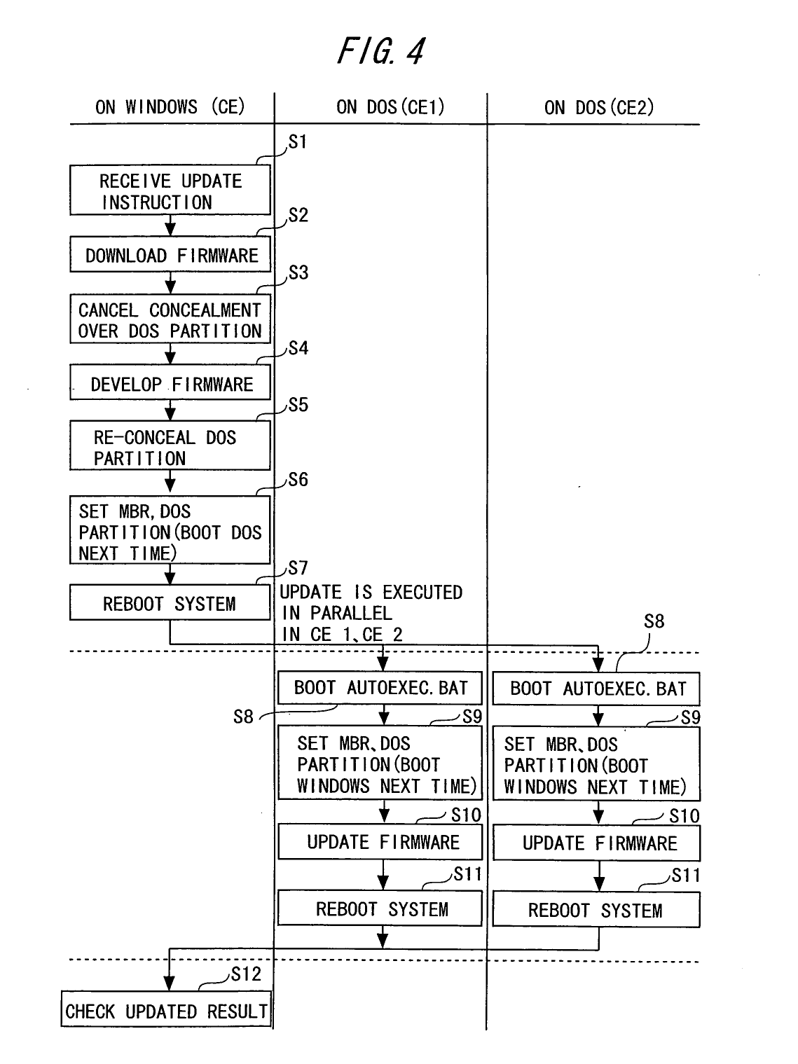

FIG. 4 is a flowchart showing an example of the automatic updating operation. In the initial status, on the computer 1 (and 2) configuring the virtual computer, the first OS is booted. In this status, the computers 1 and 2 configuring the virtual computer receive an update instruction from the operation terminal 5 (S1). At this time, together with the update instruction, the firmware is downloaded from the operation terminal 5 (S2).

Next, the computers 1 and 2 execute canceling the concealment over the second OS area 37A (e.g., the DOS partition) (S3). The cancellation of concealment implies making the second OS area 37A accessible from the first OS. This is an operation of setting a partition ID of the partition containing the second OS area 37A to a management object of the first OS.

Subsequently, the computers 1 and 2 develop the downloaded firmware (that is what is shown in FIG. 2) in the second OS storage area 37A (S4).

Next, the computers 1 and 2 execute re-concealing the second OS area 37A (e.g., the DOS partition) (S5). This is an operation of setting a partition ID of the partition containing, e.g., the second OS area 37A to a partition excluded from the management object of the first OS.

The computers 1 and 2 set the second OS (e.g., DOS) as the OS that is booted next time in the master boot record 35A and the second OS area 37A (S6).

Then, the computers 1 and 2 reboot the system (S7). At this time, the computers 1 and 2 are at first shut down, whereby the synchronizing process with respect to each other is stopped. Thereafter, the boot process is executed. From this boot process onward, the computers 1 and 2 solely execute the process. At this time, the computers 1 and 2 take neither the synchronization nor the redundant configuration. Hence, the computers 1 and 2 respectively execute the following update in parallel.

To begin with, the computer 1 (described as CE 1 in FIG. 4) and the computer 2 (described as CE 2 in FIG. 4) boot the second OSs based on the settings in the master boot records 35A. After booting the second OSs, each of the computers 1 and 2 starts up Autoexec.bat (S8).

Next, each of the computers 1 and 2 sets the first OS (e.g., Windows) as the OS to be booted next time in the master boot record 35A and in the second OS area 37A (S9).

Moreover, each of the computers 1 and 2 executes updating the firmware (S10). Then, the computers 1 and 2 reboot the computers themselves (S11).

Thereafter, the first OS is booted based on the setting in the master boot record 35A. Note that when booting the first OS, at first the computer 1 is started up. Then, a content in the memory of the computer 1 is copied (mirrored) to the memory of the computer 2, thus starting the synchronizing process between the computers 1 and 2. Thereafter, the execution of the hardware processing is done according to the updated result, and the updated result is verified (S12).

It is to be noted that the computers 3 and 4 operate as the I/O processors during the boot process of each of the computers 1 and 2 described above.

As discussed above, according to the present information system, the firmware included in the plurality of computers can be updated in the virtual computer system taking the redundant configuration among the plurality of computers.

Further, according to the present information system, the second OS area 37A stored with the firmware to be updates is concealed in the normal operating status. It is therefore possible to prevent the crash action at the second OS area 37A or the crash action at the firmware.

<Modified Example>

In the embodiment discussed above, the virtual computer is configured by the computers 1, 2 and the computers 3, 4 providing the computers 1, 2 with the functions of the I/O processors. The embodiment of the present invention is not, however, limited to this configuration. For example, the computers 3, 4 providing the functions of the I/O processors are not necessarily required. Namely, the present invention can be embodied also with a configuration that the LAN boards, the hard discs, etc. are connected to the I/O interfaces of the computers 1, 2.

### INDUSTRIAL APPLICABILITY

The present invention can be applied to updating the firmware within the virtual computer system configured by the plurality of computers.

What is claimed is:

1. A virtual computer system including a plurality of computers each having a first operating system executed when configuring said virtual computer system and a second operating system used when said computers individually function,
said computer comprising:
a boot module starting up said first operating system or said second operating system;
a rewriting unit updating firmware of said computer when starting up said second operating system;
a unit setting said boot module so as to start up said first operating system;
a unit restarting up said computer; and
a unit configuring said virtual computer system by synchronization with at least one other computer when said first operating system is started up,
wherein in a virtual computer system configured status, there are provided a unit setting said boot module so as to start up said second operating system and a unit stopping said virtual computer system.

2. A virtual computer system according to claim 1, wherein each of said computers includes a first computer having an input/output unit and a second computer employing the input/output unit of said first computer, and
said second computer is provided with at least a boot module starting up said first operating system or said second operating system, and a rewriting unit updating firmware of said second computer when starting up said second operating system.

3. A virtual computer system according to claim 2, wherein said boot module is set in an unaccessible protected status in a virtual computer configured status, and
said unit setting said boot module so as to start up said second operating system has a unit that accesses said boot module in the protected status.

4. A firmware updating method in a virtual computer system including a plurality of computers each having a first operating system executed when configuring a virtual computer system and a second operating system used when said computers individually function, said computer including a boot module for starting up said first operating system or said second operating system,
said method comprising steps of:
updating firmware of said computer when starting up said second operating system;
setting said boot module so as to start up said first operating system;
restarting up said computer; and
configuring said virtual computer system by synchronization with at least one other computer when said first operating system is started up,
wherein in a virtual computer configured status, there are executed setting said boot module so as to start up said second operating system and stopping said virtual computer system.

5. A firmware updating method in a virtual computer system according to claim 4, wherein said virtual computer configuring step includes setting said boot module in an unaccessible protected status, and
said step of setting said boot module so as to start up said second operating system includes canceling the protected status of said boot module kept in the protected status and recovering the protected status.

6. A computer configuring a virtual computer system, said computer executing a first operating system when configuring said virtual computer system in cooperation with other computers and executing a second operating system when individually functioning,
said computer comprising:
a boot module starting up said first operating system or said second operating system;
a rewriting unit updating firmware of said computer when starting up said second operating system;
a unit setting said boot module so as to start up said first operating system;
a unit restarting up said computer; and
a unit configuring said virtual computer system by synchronization with at least one other computer when said first operating system is started up,
wherein in a virtual computer system configured status, there are provided a unit setting said boot module so as to start up said second operating system and a unit stopping said virtual computer system.

7. A program making a computer as a virtual computer system, said computer executing a first operating system when configuring said virtual computer system in cooperation with other computers and executing a second operating system when individually functioning, and including a boot module for starting up said first operating system or said second operating system,
said program comprising:
updating firmware of said computer when starting up said second operating system;
setting said boot module so as to start up said first operating system;
restarting up said computer; and
configuring said virtual computer system by synchronization with at least one other computer when said first operating system is started up,
said program, in a virtual computer configured status, further comprising:
setting said boot module so as to start up said second operating system; and
stopping said virtual computer system.
